(19) United States
(12) Patent Application Publication
(10) Pub. No.: US 2009/0328168 A1
(43) Pub. Date: Dec. 31, 2009

(54) METHOD FOR REGISTERING AND CERTIFICATING USER OF ONE TIME PASSWORD BY A PLURALITY OF MODE AND COMPUTER-READABLE RECORDING MEDIUM WHERE PROGRAM EXECUTING THE SAME METHOD IS RECORDED

(75) Inventor: Changhee Lee, Sungnam (KR)

Correspondence Address: Edwards Angell Palmer & Dodge LLP, P.O. Box 55874, Boston, MA, 02205, US

(73) Assignee: INITECH CO., LTD., Seoul (KR)

(21) Appl. No.: 12/441,310

(22) PCT Filed: Apr. 18, 2007
(86) PCT No.: PCT/KR07/01890

§ 371 Date: Mar. 13, 2009

(30) Foreign Application Priority Data
Sep. 15, 2006 (KR) 10-2006-0089569
Mar. 19, 2007 (KR) 10-2007-0026677

(51) Int. Cl. G06F 17/00

(52) U.S. Cl. 726/6

(57) ABSTRACT

The present invention relates to a method of registering a one-time-password user in a one-time-password terminal by the one-time-password terminal, in an environment including the one-time-password terminal loaded with a program for creating one-time-passwords in a plurality of modes, an authentication server for authenticating authenticity of the one-time-password user, a one-time-password server, and a one-time-password database server for storing information on the one-time-password user.

### TECHNICAL FIELD

The present invention relates to a method of registering a user of a one-time-password and a computer readable recoding medium having a program recorded therein for executing such a method, and more specifically, to a method of registering a user of a one-time-password in a plurality of modes at one one-time-password terminal and a computer readable recoding medium having a program recorded therein for executing such a method.

### BACKGROUND ART

In general, an ordinary password has a fixed value designated by a user, and the user is responsible for managing the password not to be leaked. However, when an Internet banking or phone banking transaction is performed, it occurs frequently that a password being inputted by a user is hacked or snatched by a third party in a communication network, leading to imposing unexpected damages on the user through the illegal password.

A one-time-password (OTP) has been appeared to prevent such a problem, and since such a one-time-password is valid only once and another password is created in the next time, so that although someone intercepts the password in the middle and uses it, the password is already invalid at that time, and thus safety is relatively increased as compared with a conventional fixed password that maintains a fixed value.

A one-time-password can be created using a separate terminal, or a one-time-password creation program downloaded to a cellular phone or the like. The created one-time-password can be used at an automatic teller machine (ATM) or for Internet banking.

Recently, as the usefulness of the one-time-password is widely known, many financial institutes or the like competitively recommend customers to use the one-time-password in a banking transaction. However, there is a quite difference between methods of creating the one-time-password among the financial institutes. That is, examples of the method of creating the one-time-password include a method of using a 64-bit string and a 128-bit string, a method of using 4 digits and 8 digits, a method of using only digits or a combination of digits and characters, and so on. Some financial institutes do not allow for creation of a password itself with a string that is the same as user identification or a numeric string containing a birth date.

Accordingly, since a program containing a fixed password creation mode as an algorithm cannot be used to create a password of another institute that uses a different password creation mode, a user who has accounts at a plurality of financial institutes suffers from inconvenience of having to carry a plurality of one-time-password terminals or install a plurality of one-time-password creation programs provided and downloaded from the plurality of financial institutes to a cellular phone or the like.

### DISCLOSURE OF INVENTION

### Technical Problem

Accordingly, the present invention has been made in order to solve the above problems, and it is an object of the invention to provide a method of registering a user of a one-time-password, in which one-time-passwords requested by a plurality of financial institutes that use a different one-time-passwords creation mode can be created by one one-time-password creation program. Furthermore, another object of the present invention is to provide a computer readable recoding medium having a program recorded therein for executing such a method.

That is, the present invention relates to a method of creating and registering a on e-time-password in accordance with a one-time-password creation mode of each financial institute by installing one program in a one-time-password terminal. After storing information on one-time-password creation modes used by respective financial institutes in a one-time-password server, information on a one-time-password creation mode appropriate for a financial institute selected by a user (register) is transmitted to the one-time-password terminal, and a program loaded on the one-time-password terminal creates a one-time-password based on the transmitted mode. Through the configuration described above, all kinds of passwords of financial institutes that use a different one-time-password creation mode can be created and registered using a one-time-password terminal loaded with one program.

### Technical Solution

In order to accomplish the above objects of the invention, according to one aspect of the invention, there is provided a method of registering a one-time-password user in a one-time-password terminal, in an environment including the one-time-password terminal loaded with a program for creating one-time-passwords in a plurality of modes, an authentication server for authenticating authenticity of the one-time-password user, a one-time-password server, and a one-time-password database server for storing information on the one-time-password user, the method comprising: a first step of allowing the one-time-password terminal to request both a profile of an institute for a corresponding one-time-password to be used and a serial number of the program for creating the one-time-password from the one-time-password server; a second step of allowing the one-time-password terminal to receive the serial number and the profile issued by the one-time-password server from the one-time-password server; and a third step of allowing the one-time-password terminal to register the profile and the password in the one-time-password terminal and generate a seed value, wherein the serial number received in the second step is transferred to and registered in the authentication server by the user, the profile is information on a corresponding one-time-password creation mode and information on the institute, and the one-time-password is created by the one-time-password terminal in a one-time-password creation mode determined by the profile.

According to another aspect of the invention, there is provided a method for allowing a one-time-password server to authenticate a first one-time-password inputted by a user, in an environment including a one-time-password terminal loaded with a program for creating one-time-passwords in a plurality of modes, an authentication server for authenticating authenticity of the one-time-password user, the one-time-password server, and a one-time-password database server for storing information on the one-time-password user, the method comprising: a first step of allowing the one-time-password server to receive user information and the first one-time-password from the authentication server; a second step of allowing the one-time-password server to inquire and receive a seed value from the one-time-password database server based on the user information; a third step of allowing the one-time-password server to create a second one-time-password based on the seed value; and a fourth step of allowing the one-time-password server to compare the first one-time-password with the second one-time-password and transfer a result of the comparison to the authentication server, wherein the first one-time-password is created by the user using the one-time-password terminal and transferred to the authentication server.

According to the configuration of the present invention described above, a profile of a financial institute is transferred from the one-time-password server, and a one-time-password is created in a one-time-password creation mode determined through the profile. Therefore, one-time-passwords can be created by one program in a plurality of one-time-password creation modes specified by a plurality of financial institutes. It is apparent that a financial institute should be selected by the program.

The first to fourth steps are repeated as many times as the number of one-time-password creation modes.

The computer readable recoding medium according to the present invention is a computer readable recoding medium having a program recorded therein for executing the above-mentioned steps.

The terminology OTP is used among those skilled in the art to refer to the one-time-password used in the present specification and figures.

An environment for performing the present invention includes a one-time-password terminal 10 loaded with a program for creating one-time-passwords, a user computer 20, an authentication server 30 for authenticating authenticity of a one-time-password user, a one-time-password server 40, and a one-time-password database server 50 for storing information on the one-time-password user.

The one-time-password terminal 10 is a terminal for creating a one-time-password, which can be a dedicated terminal or a cellular phone where a program for creating one-time-passwords is loaded. The user computer 20 includes all kinds of electronic devices connected to a communication network and capable of communicating with the authentication server 30.

The authentication server 30 means a server of a financial institute, such as a bank or the like, that uses the one-time-password in a transaction, and the authentication server 30 stores user information including information on financial accounts of one-time-password users. In order to register a user in the one-time-password server 40, the one-time-password user should obtain authentication through the authentication server 30.

### ADVANTAGEOUS EFFECTS

According to the present invention, in a program for creating one-time-passwords, provided is an effect of creating one-time-passwords in a plurality of modes provided by a plurality of financial institutes with one program.

That is, all kinds of passwords of financial institutes that use a different one-time-password creation mode can be created and registered using a one-time-password terminal loaded with one program. Therefore, a user who has accounts at a plurality of financial institutes can be relieved from inconvenience of carrying a plurality of one-time-password terminals or installing a plurality of one-time-password creation programs provided and downloaded from the plurality of financial institutes in a cellular phone or the like.

### BEST MODE FOR CARRYING OUT THE INVENTION

Further objects and advantages of the invention can be more fully understood from the following detailed description taken in conjunction with the accompanying drawings in which:

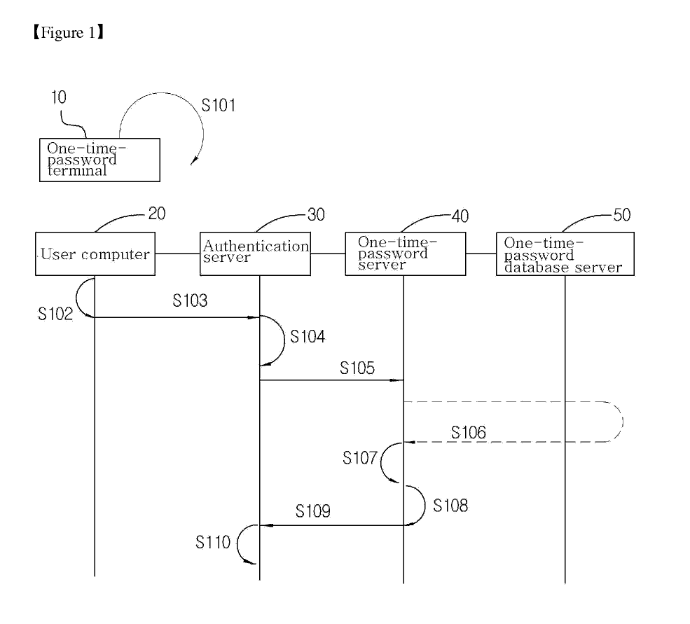

FIG. 1 is a view showing a method of authenticating a user in a method of registering a user according to the present invention;

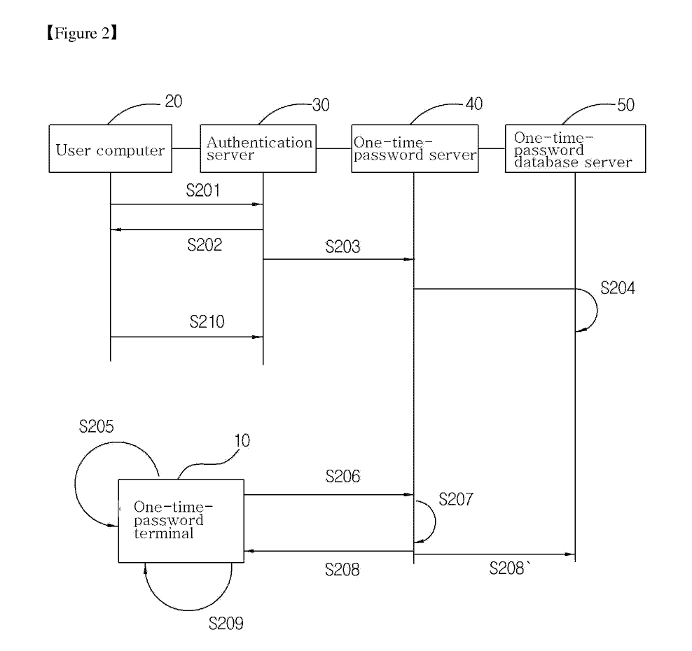

FIG. 2 is a view showing a method registering a user according to the present invention;

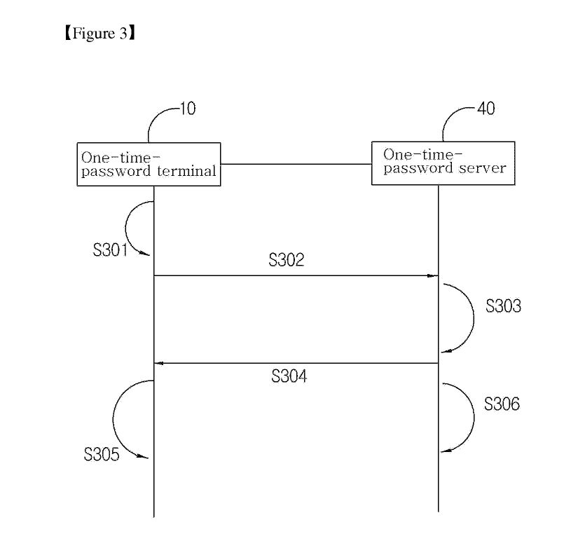

FIG. 3 is a view showing a process of sharing a key in registering a user according to the present invention;

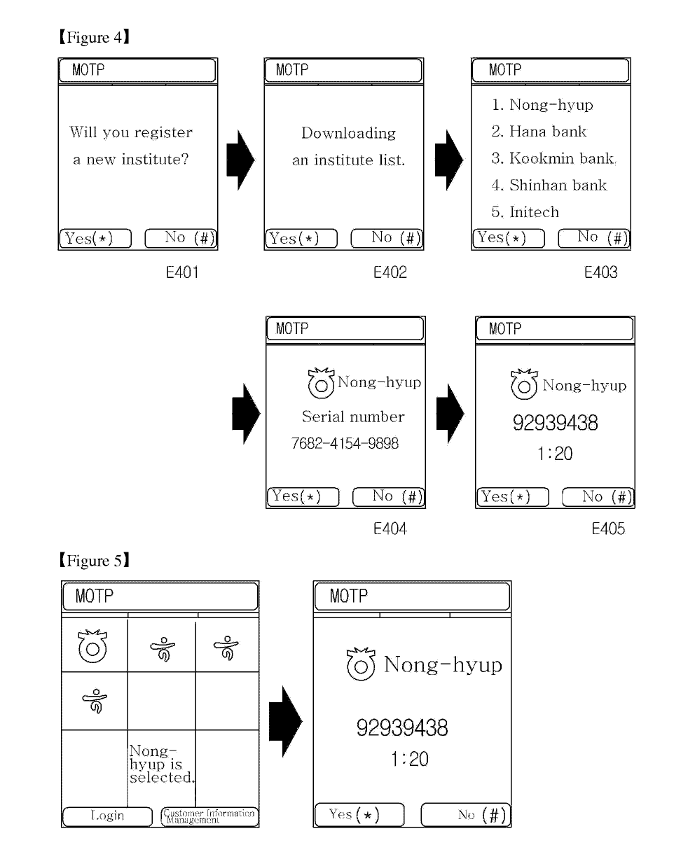

FIG. 4 is a view showing an embodiment implementing a process of registering a one-time-password user at a one-time-password terminal according to the present invention; and

FIG. 5 is a view showing an embodiment implementing a process of creating a one-time-password and authenticating the one-time-password from a registered institute using a one-time-password terminal.

### MODE FOR THE INVENTION

Hereinafter, the preferred embodiments of the present invention will be described in detail with reference to the accompanying drawings.

First, FIG. 1 shows a flowchart illustrating a method of authenticating a user according to the present invention and constitutional components of an environment for performing the user authentication method. In the process shown in FIG. 1, it is assumed that a banking transaction is performed through an electronic device such as a computer or the like.

A user connects to a web-site of a financial institute with which the user has an account in order to perform a financial transaction, such as Internet banking, through an electronic device, such as a computer or the like. In this case, a one-time-password is required to perform Internet banking or the like.

The one-time-password terminal 10 creates a first one-time-password in step S101. The first one-time-password is preferably created based on a seed value created, encrypted, and stored in the step of registering a one-time-password user S209 shown in FIG. 2.

If the created first one-time-password is inputted into the computer 20, the computer 20 transfers user's identification (ID) and the first one-time-password to the authentication server 30 through a communication network S103.

Here, the user ID can be personal information including information on an account or the like that the user has at a financial institute that uses a one-time-password in a financial transaction.

The authentication server 30 that receives the user ID and the first one-time-password confirms whether the user is authorized in step S104. This is to confirm whether the user is registered as a one-time-password user in the authentication server 30 in the step of registering a one-time-password user S210 shown in FIG. 2. If the user is confirmed to be an authorized user, user information and the first one-time-password value are transferred to the one-time-password server 40 in step S105. The user information is preferably an institute code of an institute where the first one-time-password is used, the user ID, and the like. The one-time-password server 40 inquires a seed value of the corresponding user for the institute where the first one-time-password is used from the one-time-password database server 50 based on the transferred information and receives a return value S106. The seed value is preferably the value transferred to the one-time-password server 50 in the step of registering a one-time-password user S208 shown in FIG. 2.

The one-time-password server 40 that receives the seed value creates a second one-time-password in step S107 based on the seed value received in step S106. Then, the one-time-password server compares the created second one-time-password with the first one-time-password S108. The one-time-password server transfers a result of the comparison to the authentication server 30 in step S109, and the authentication server 30 performs authentication in connection with an existing authentication server and releases the connection S110.

If the user has accounts at a plurality of financial institutes, the user should perform a user registration in order to create one-time-passwords in a plurality of modes using one program at the one-time-password terminal 10, and FIG. 2 shows the process of such a user registration.

First, a user logs in the authentication server 30 using the computer 20 S201. The authentication server 30 requests to use a one-time-password to the computer 20 of the user in step S202 and transfers the institute code of an institute where the one-time-password is used and user ID to the one-time-password server 40 in step S203. The institute code means a unique identifier that can identify an institute where the one-time-password is used from other institutes, and the user ID can be personal information including information on an account or the like that the user has at a financial institute where the one-time-password is used.

The one-time-password server 40 transfers the institute code and the user ID to the one-time-password database server, and the one-time-password database server registers the user ID based on the transferred institute code and user ID S204.

On the other hand, the user executes a virtual machine (VM) of the one-time-password terminal 10 in step S205, and selects and handles an institute registration menu that can be included in the VM. Here, the VM is a terminology used by those skilled in the art, referring to software that functions as an interface between a complied binary code and a microprocessor that actually executes program instructions.

The VM generates a certain random value through the institute registration menu. The random value is preferably a nonce for stability. Unlike a general random value, if the same values are consecutively generated, the nonce discards the latter value and re-generates a random value that is not the same. The one-time-password terminal 10 may transfer the random value generated through the VM to the one-time-password server 40, or may not transfer and only save the generated random value. In addition, the one-time-password terminal requests the profile and a serial number of an institute where the one-time-password is used from the one-time-password server S206.

The one-time-password server 40 issues a serial number and a seed value in response to the request S207. The serial number means a unique number of a program loaded on the one-time-password terminal. The serial number and the seed value are preferably independent values created without having a functional relation to each other, and the seed value is preferably determined as unique information mapped to the serial number.

The one-time-password server 40 transfers the profile of the institute where the one-time-password is used requested in step S206 and the serial number issued in step S207 to the one-time-password terminal 10 S208, and transfers the seed value issued in step S207 to the one-time-password database server 50 S208. The seed value stored in the one-time-password database server 50 is used to confirm whether the seed value is matched in step S106 in the user authentication process shown in FIG. 1.

The one-time-password terminal 10 registers the transferred profile and serial number and generates a separate seed value S209. That is, the transferred information is encrypted and processed in a method that uses the seed value.

The user inputs the serial number received in step S209 through the computer 20, and the computer 20 transfers the inputted serial number to the authentication server 30, thereby completing the user registration process S210. At this point, it is preferable to input an initial one-time-password value together, and the seed value generated in step S209 is stored in a state encrypted based on the initial one-time-password.

These steps can be repeated as many times as the number of financial institutes with which a customer has accounts. That is, the user selects financial institutes where one-time-passwords are used and iterates the steps shown in FIG. 2 as many times as the number of the desired financial institutes, and thus a profile of a corresponding financial institute and a seed value of the corresponding financial institute for the corresponding user are shared.

The profile includes information on a one-time-password creation mode of a financial institute where the one-time-password is used and information on the financial institute itself. Preferably, the profile may include information on a one-time-password creation interval specifying at which minute intervals the one-time-password is created again, information on a one-time-password creation algorithm, the size of the one-time-password, information on whether the last digit of the created one-time-password is used as a checksum, information on whether the one-time-password is set when the one-time-password terminal is executed, a service name, a service logo icon, guide messages of a customer service center, and the like.

Generally, the one-time-password creation algorithm includes a challenge-response method, a time-synchronization method, an event-synchronization method, a combination method, and the like, but other methods also can be used. Its algorithm is well-known among those skilled in the art.

The one-time-password terminal 10 creates a one-time-password in a one-time-password creation mode of a financial institute, where the one-time-password is used, contained in the profile. The profile specified by each financial institute is different, and the one-time-password creation mode of each financial institute contained in the profile is transferred to the one-time-password terminal 10. A program loaded on the one-time-password terminal applies the one-time-password creation mode of each financial institute when creating a one-time-password, and thus all kinds of one-time-passwords having a different creation mode can be created with one program. That is, a password creation mode is not fixedly embedded in the program loaded on the one-time-password terminal 10, but information on the one-time-password creation mode of each financial institute where the one-time-password is used is received from the one-time-password server 40 and used by the program whenever needed. Therefore, all kinds of one-time-passwords having a different creation mode can be created with one program.

FIG. 3 shows a process of sharing a seed in the process of registering a one-time-password by a user. The one-time-password terminal 10 and the one-time-password server 40 use a method of sharing a secret key through public key encryption.

First, the one-time-password terminal 10 generates a first temporary random value in step S301. The random value is preferably a nonce. The first temporary random value is transferred to the one-time-password server 40 through public key encryption in step S302, and the one-time-password server 40 generates a second temporary random value S303 and transfers the second temporary random value to the one-time-password terminal 10 through public key encryption S304. At this point, the second temporary random value is preferably used as a serial number.

Then, the one-time-password terminal 10 and the one-time-password server 40 respectively receive the temporary random value created by itself and the temporary random value created by the other side and generate a seed by combining the temporary random values with a secret key in step S305 and S306. Accordingly, a value that is hashed using the first temporary random value, the second temporary random value, and the secret key as variables is preferably used as the seed.

SEED creation H(n)[Client Nonce|Server Nonce|Secret Key]

FIG. 4 is a view showing an embodiment implementing a process of registering a one-time-password user at a one-time-password terminal according to the present invention. As shown in FIG. 2, a user executes a virtual machine (VM) of the one-time-password in step S205, and selects and handles an institute registration menu that can be included in the VM. At this point, the one-time-password terminal inquires whether a new financial institute will be registered, and if the user selects an affirmative, a list of financial institute that can be registered is arranged, and the user selects a financial institute to be registered.

Next, the one-time-password terminal requests a profile and a serial number of the selected financial institute from the one-time-password server, and creates and transmits a random value together with the request. The one-time-password server that receives the random value issues a serial number and a seed value and transmits the issued serial number and seed value to the one-time-password terminal 10, and the serial number is displayed on the one-time-password terminal 10. In addition, it is possible to create an initial one-time-password at the same time. The exemplary screen E404 is a screen displaying a serial number issued by the one-time-password server, and the exemplary screen E405 is a screen displaying a one-time-password created by a program loaded on the one-time-password terminal in accordance with the received profile of a financial institute. The user transfers the serial number and the one-time-password to the authentication sever 30 using the computer 20, and the user registration is completed S210.

FIG. 5 is an exemplary view showing a process of creating a one-time-password and authenticating the one-time-password from a registered institute using the one-time-password terminal 10. If the one-time-password terminal 10 is executed, registered institutes are displayed. If the user selects a desired institute, the one-time-password terminal creates a one-time-password. Using the created one-time-password, the user can obtain user authentication for a desired financial transaction (authentication of Internet banking or authentication of an ATM machine). Details thereof have been described referring to FIG. 1.

### INDUSTRIAL APPLICABILITY

As described above, according the present invention, in a program for creating one-time-passwords, provided is an effect of creating one-time-passwords in a plurality of modes provided by a plurality of financial institutes with one program.

That is, all kinds of passwords of financial institutes that use a different one-time-password creation mode can be created and registered using a one-time-password terminal loaded with one program. Therefore, a user who has accounts at a plurality of financial institutes can be relieved from inconvenience of carrying a plurality of one-time-password terminals or installing a plurality of one-time-password creation programs provided and downloaded from the plurality of financial institutes in a cellular phone or the like.

1. A method of registering a one-time-password user in a one-time-password terminal by using the one-time-password terminal, in an environment including the one-time-password terminal loaded with a program for creating one-time-passwords in a plurality of modes, an authentication server for authenticating authenticity of the one-time-password user, a one-time-password server, and a one-time-password database server for storing information on the one-time-password user, the method comprising:
a first step of allowing the one-time-password terminal to request from the one-time-password server both a profile of an institute for a corresponding one-time-password to be used and a serial number of the program for creating the one-time-password;
a second step of allowing the one-time-password terminal to receive from the one-time-password server the serial number and the profile issued by the one-time-password server; and
a third step of allowing the one-time-password terminal to register the profile and the password in the one-time-password terminal and generate a seed value,
wherein the serial number received in the second step is transferred to and registered in the authentication server by the user, the profile includes information on a corresponding one-time-password creation mode and information on the institute, and the one-time-password is created by the one-time-password terminal in a one-time-password creation mode determined by the profile.

2. The method according to claim 1, wherein the first to third steps are repeated as many times as the number of the one-time-password creation modes.

3. The method according to claim 1, wherein the profile includes at least one selected from the group consisting of information on a one-time-password creation interval specifying at which minute intervals the one-time-password is created again, information on a one-time-password creation algorithm, the size of the one-time-password, information on whether a last digit of the created one-time-password is used as a checksum, information on whether the one-time-password is set when the one-time-password terminal is executed, a service name, a service logo icon, and guide messages of a customer service center.

4. A computer readable program product in a computer readable storage medium for registering a one-time-password user in a one-time-password terminal by using the one-time-password terminal, in an environment including a one-time-password terminal loaded with a program for creating one-time-passwords in a plurality of modes, an authentication server for authenticating authenticity of the one-time-password user, a one-time-password server, and a one-time-password database server for storing information on the one-time-password user, the product comprising:
a program code for allowing the one-time-password terminal to request from the one-time-password server both a profile of an institute for a corresponding one-time-password to be used and a serial number of the program for creating the one-time-password;
a program code for allowing the one-time-password terminal to receive from the one-time-password server the serial number and the profile issued by the one-time-password server; and
a program code for allowing the one-time-password terminal to register the profile and the password in the one-time-password terminal and generate a seed value,
wherein the serial number received in the second step is transferred to and registered in the authentication server by the user, the profile includes information on a corresponding one-time-password creation mode and information on the institute, and the one-time-password is created by the one-time-password terminal in a one-time-password creation mode determined by the profile.

5. A method for allowing a one-time-password server to authenticate a first one-time-password inputted by a user, in an environment including a one-time-password terminal loaded with a program for creating one-time-passwords in a plurality of modes, an authentication server for authenticating authenticity of the one-time-password user, the one-time-password server, and a one-time-password database server for storing information on the one-time-password user, the method comprising:
a first step of allowing the one-time-password server to receive user information and the first one-time-password from the authentication server;
a second step of allowing the one-time-password server to inquire and receive a seed value from the one-time-password database server based on the user information;
a third step of allowing the one-time-password server to create a second one-time-password based on the seed value; and a fourth step of allowing the one-time-password server to compare the first one-time-password with the second one-time-password and transfer a result of the comparison to the authentication server,
wherein the first one-time-password is created by the user using the one-time-password terminal and transferred to the authentication server.

6. A computer readable program product in a computer readable storage medium for allowing a one-time-password user to authenticate a first one-time-password inputted by a user, in an environment including a one-time-password terminal loaded with a program for creating one-time-passwords in a plurality of modes, an authentication server for authenticating authenticity of the one-time-password user, the one-time-password server, and a one-time-password database server for storing information on the one-time-password user, the product comprising:
a program code for allowing the one-time-password server to receive user information and a first one-time-password from the authentication server;
a program code for allowing the one-time-password server to inquire and receive a seed value from the one-time-password database server based on the user information;
a program code for allowing the one-time-password server to create a second one-time-password based on the seed value; and
a program code for allowing the one-time-password server to compare the first one-time-password with the second one-time-password and transfer a result of the comparison to the authentication server,
wherein the first one-time-password is created by the user using the one-time-password terminal and transferred to the authentication server.
